(19) United States
(12) Patent Application Publication
(10) Pub. No.: US 2026/0369239 A1
(43) Pub. Date: Nov. 19, 2026

(54) METHOD FOR CONTROLLING LIGHT EMITTING OF DISPLAY SCREEN AND DISPLAY SCREEN

(71) Applicant: Shenzhen China Star Optoelectronics Semiconductor Display Technology Co., Ltd., Shenzhen (CN)

(72) Inventors: Jianzhong XIAO, Shenzhen (CN); Hua ZHANG, Shenzhen (CN); Yanzhou XIONG, Shenzhen (CN); Huaiyu WANG, Shenzhen (CN)

(21) Appl. No.: 19/390,507

(22) Filed: Nov. 15, 2025

Related U.S. Application Data
(63) Continuation of application No. PCT/CN2025/130715, filed on Oct. 28, 2025.

(30) Foreign Application Priority Data
May 13, 2025 (CN) 202510615900.5

(51) Int. Cl. G09G 3/34

(52) U.S. Cl. CPC G09G 3/342; G09G 2320/0233; G09G 2320/064

(57) ABSTRACT

A method for controlling light emitting of a display screen. The method includes generating a plurality of backlight driving signals based on a quantity of backlight units, where each backlight driving signal is configured to control one of the backlight units to emit light, and at least two of the backlight driving signals have different phases; and driving the backlight units to emit light respectively based on the plurality of backlight driving signals in a display period of one frame of image, such that at least two of the backlight units have different light emitting timings.

### CROSS-REFERENCE TO RELATED APPLICATION

The present application is a U.S. continuation of International patent application PCT/CN2025/130715 filed on Oct. 28, 2025, which claims the priority to Chinese patent application with application number 202510615900.5 filed on May 13, 2025, the content of the aforementioned applications is incorporated herein by reference in its entirety.

### TECHNICAL FIELD

The present disclosure relates to the field of display technology, in particular, to a method for controlling light emitting of a display screen and the display screen.

### BACKGROUND

As a core carrier for information interaction and visual experience, display screens have been widely used in fields such as mobile phones, computers and televisions. For example, a liquid crystal display screen can provide light for the screen through a backlight unit including light-emitting devices (e.g., LED lamp beads). The light passes through optical structures such as a light guide plate, a diffusion film, or a brightness enhancement film to eliminate light spots or dark areas and convert the originally linear light source into a uniform surface light source for the entire display screen.

In some common control methods for backlight units at present, the backlight units are turned on and off simultaneously, and their light emitting timings are synchronized. When the display screen presents a high-gray-scale image, since the brightness of the image itself is relatively high, problems such as bright stripes or uneven brightness rarely occur. However, when the display screen presents a low-gray-scale image, due to the relatively low brightness of the image, slight changes in voltage and current are likely to affect the display effect under the influence of factors such as the conductive materials of the display screen, resulting in alternating bright and dark stripes on the display screen, which forms a waterfall pattern and affects the display effect.

### SUMMARY

The following is a summary of the subject matter described in detail herein. This summary is not intended to limit the scope of protection of the claims.

The present disclosure provides a method for controlling light emitting of a display screen and the display screen.

In a first aspect, the present disclosure provides a method for controlling light emitting of a display screen. The display screen includes a plurality of backlight units arranged in sequence along a predetermined direction. The predetermined direction is perpendicular to a display scanning direction of the display screen. The method includes generating a plurality of backlight driving signals based on a quantity of the backlight units, where each backlight driving signal is configured to control one of the backlight units to emit light, and at least two of the backlight driving signals have different phases; driving the backlight units to emit light respectively based on the plurality of backlight driving signals in a display period of one frame of image, such that at least two of the backlight units have different light emitting timings.

In some embodiments, the generating of the plurality of backlight driving signals based on the quantity of the backlight units includes obtaining a period interval amount based on a predetermined period of the backlight driving signals and the quantity of the backlight units; generating a phase offset amount for each of the backlight driving signals based on the period interval amount; generating a backlight driving signal corresponding to each backlight unit based on a predetermined duty cycle, the predetermined period and the phase offset amounts of the backlight driving signals.

In some embodiments, the predetermined period is less than or equal to the display period of the one frame of image.

In some embodiments, the predetermined duty cycle is greater than or equal to 1/N, where N is the quantity of the backlight units.

In some embodiments, the driving of the backlight units to emit light respectively based on the plurality of backlight driving signals such that at least two of the backlight units have different light emitting timings includes inputting the plurality of backlight driving signals to corresponding backlight units based on the phase offset amount of each backlight driving signal, such that at least two of the backlight units have different light emitting timings.

In some embodiments, the inputting of the plurality of backlight driving signals to the corresponding backlight units based on the phase offset amount of each backlight driving signal includes inputting at least two backlight driving signals with a target phase difference to corresponding target backlight units, respectively, where there is at least one other backlight unit between any two target backlight units, such that the light emitting timings of adjacent backlight units are separated by at least 2/N of the predetermined period; where N is the quantity of the backlight units, and the target phase difference refers to a difference between phase offset amounts being the period interval amount.

In some embodiments, the inputting of the plurality of backlight driving signals to the corresponding backlight units based on the phase offset amount of each backlight driving signal such that at least two of the backlight units have different light emitting timings includes inputting each of the backlight driving signals to corresponding backlight unit in accordance with an arrangement order of the backlight units and based on an order of magnitudes of the phase offset amounts of the plurality of backlight driving signals, such that the light emitting timings of adjacent backlight units are sequentially separated by 1/N of the predetermined period; where N is the quantity of the backlight units.

In some embodiments, the backlight units are divided into a plurality of backlight groups; the backlight driving signals include a plurality of first signal groups, phases of each of the backlight driving signals in a same first signal group are equal, and phases of the backlight driving signals in different first signal groups are different; the driving of the backlight units to emit light respectively based on the plurality of backlight driving signals such that at least two of the backlight units have different light emitting timings includes inputting the plurality of first signal groups to respective backlight groups, such that the backlight units in a same backlight group have a same light emitting timing and the backlight units in different backlight groups have different light emitting timings.

In some embodiments, the backlight units are divided into a plurality of backlight groups; the backlight driving signals include a plurality of second signal groups, and phases of the backlight driving signals in a same second signal group are different; the driving of the backlight units to emit light respectively based on the plurality of backlight driving signals such that at least two of the backlight units have different light emitting timings includes inputting the plurality of second signal groups to respective backlight groups, such that the backlight units in a same backlight group have different light emitting timings, and each backlight unit in each backlight group has a same light emitting timing as one of the backlight units in another backlight group.

In a second aspect, the present disclosure provides a display screen, including a plurality of backlight units, arranged in sequence along a predetermined direction, where the predetermined direction is perpendicular to a display scanning direction of the display screen; a light emitting control unit, connected to the backlight units and configured to perform the following operations: generating a plurality of backlight driving signals based on a quantity of the backlight units, where each backlight driving signal is configured to control one of the backlight units to emit light, and at least two of the backlight driving signals have different phases; driving the backlight units to emit light respectively based on the plurality of backlight driving signals in a display period of one frame of image, such that at least two of the backlight units have different light emitting timings.

In conclusion, in the present disclosure, a plurality of backlight driving signals with at least two different phases are generated based on the quantity of backlight units. Then, in the display period of one frame of image, the backlight units are driven to emit light based on the backlight driving signals, so that at least two of the backlight units have different light emitting timings in the display period of the one frame of image. Thus, during the charging process of pixel circuits in a same row, the pixel circuits in the same row can be charged both when the backlight units are on and when the backlight units are off. At this time, even if a bright strip is generated during the charging of the pixel circuits when the backlight units are on, the bright strip will not extend across the entire display screen. As such, the bright strips are relatively evenly distributed over the entire display screen visually, so that the waterfall pattern of the display screen can be reduced and the display effect can be improved without improving materials or manufacturing processes.

Other aspects can be understood after reading and comprehending the accompanying drawings and the detailed description.

### BRIEF DESCRIPTION OF THE DRAWINGS

In order to more clearly illustrate the technical solutions in the embodiments of the present disclosure, the accompanying drawings for describing the embodiments will be briefly introduced below. Apparently, the accompanying drawings in the following description are only some embodiments of the present disclosure. For a person having ordinary skill in the art, other accompanying drawings can also be obtained according to these accompanying drawings without exerting creative labor.

FIG. 1 is a schematic diagram of the principle of waterfall pattern generation in an embodiment of the present disclosure;

FIG. 2 is a flowchart of a method for controlling light emitting of a display screen in an embodiment of the present disclosure;

FIG. 3 is a schematic diagram of the arrangement of backlight units in an embodiment of the present disclosure;

FIG. 4 is a schematic diagram of timing diagrams of backlight driving units and display effects in a first embodiment of the present disclosure;

FIG. 5 is a schematic diagram of timing diagrams of backlight driving units and display effects in another embodiment of the present disclosure;

FIG. 6 is a schematic diagram of timing diagrams of backlight driving units and display effects in yet another embodiment of the present disclosure;

FIG. 7 is a schematic diagram of timing diagrams of backlight driving units and display effects in still yet another embodiment of the present disclosure.

### DETAILED DESCRIPTION

The technical solutions in the embodiments of the present disclosure will be clearly and completely described below in conjunction with the accompanying drawings in the embodiments of the present disclosure. Apparently, the embodiments described are only a part of the embodiments of the present disclosure, rather than all the them. Based on the embodiments in the present disclosure, all other embodiments obtained by a person having ordinary skill in the art without exerting creative labor belong to the protection scope of the present disclosure.

In the description of the present disclosure, it should be understood that the terms “first” and “second” are only used for descriptive purposes and cannot be understood as indicating or implying relative importance or implicitly indicating the number of indicated technical features. Therefore, the features defined with “first” and “second” may explicitly or implicitly include one or more of the features. In the description of the present disclosure, the meaning of “a plurality of” is two or more, unless otherwise clearly and specifically defined. In the present disclosure, the term “exemplary” is used to mean “serving as an example, illustration or explanation”. Any embodiment described as “exemplary” in the present disclosure is not necessarily to be construed as being more preferred or advantageous than other embodiments. In order to enable a person having ordinary skill in the art to implement and use the present disclosure, the following description is provided. In the following description, details are set forth for the purpose of explanation. It should be understood that a person having ordinary skill in the art can realize that the present disclosure can be implemented without using these specific details. In other instances, well-known structures and processes will not be elaborated on so as to avoid obscuring the description of the present disclosure with unnecessary details. Therefore, the present disclosure is not intended to be limited to the embodiments shown but is to be consistent with the widest scope consistent with the principles and features disclosed in the present disclosure.

In the manufacturing process of a display screen, thin film transistors and pixel electrodes are formed on a glass substrate through a four-mask process (Four Mask Process, 4Mask). In the four-mask process, when the tail structure of the second metal layer (Metal2, M2) is convex, light irradiation will enhance the conductivity of amorphous silicon (Amorphous Silicon, AS) material. When the backlight is on (Back light Unit On, BLU On), the conductivity of the amorphous silicon under the data lines (Data Line) increases, resulting in an increase in the coupling capacitance between the pixel units and the data lines. When the backlight is off (Back light Unit Off, BLU Off), the conductivity of the amorphous silicon decreases, and the coupling capacitance decreases accordingly.

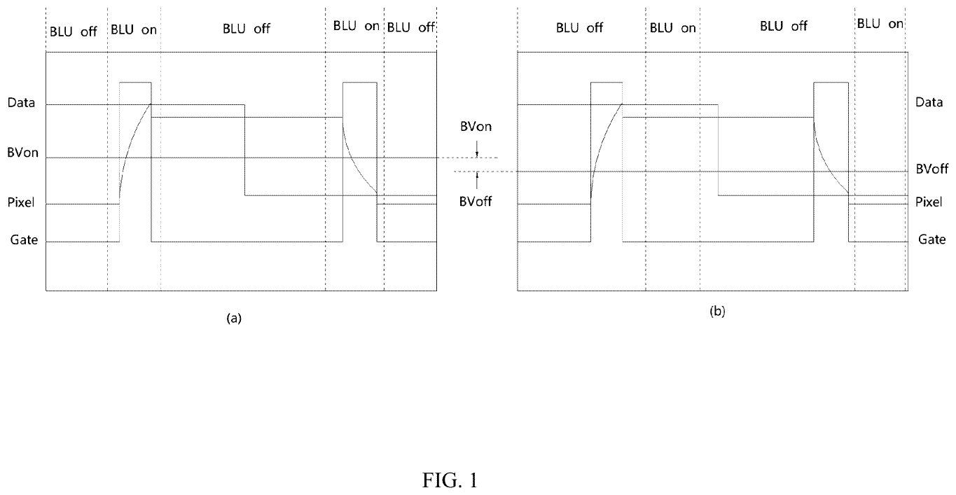

Referring to FIG. 1, where Data represents a data signal, Pixel represents a voltage change curve of a pixel circuit during charging based on the data signal, and Gate represents a gate control signal for controlling the on-off of the pixel circuit. When the gate control signal is at a high level, the pixel circuit starts to charge. BLU off indicates that the backlight unit is off, and BLU on indicates that the backlight unit is on. Accordingly, illustration (a) in FIG. 1 represents the voltage changes when the pixel circuit is in a charging state while the backlight unit is on; and illustration (b) in FIG. 1 represents the voltage changes when the pixel circuit is in a charging state while the backlight unit is off. Due to the continuous change in the coupling capacitance value when the backlight unit is in the on state and off state, the influence on the output voltage of the backlight unit differs between the first scenario—where the pixel circuit is charged during the on period of the backlight unit—and the second scenario—where the pixel circuit is charged during the off period of the backlight unit. This results in the output voltage BVon of the backlight unit in the first scenario being greater than the output voltage BVoff of the backlight unit in the second scenario. Ultimately, the backlight brightness in the first scenario is greater than that in the second scenario, leading to the appearance of bright strips on the display screen visually. During the display process of each frame of image, the backlight units need to be continuously turned on and off. As the data signals are written row by row, the data signals of the pixel circuits in some rows are written during the on period of the backlight units, while the data signals of the pixel circuits in other rows are written during the off period of the backlight units. This results in the formation of periodically alternating bright and dark waterfall patterns at different positions in the same frame of image. Especially when displaying low-gray-scale images, the waterfall pattern phenomenon becomes more severe.

In view of the above, embodiments of the method for controlling light emitting of a display screen of the present disclosure are proposed.

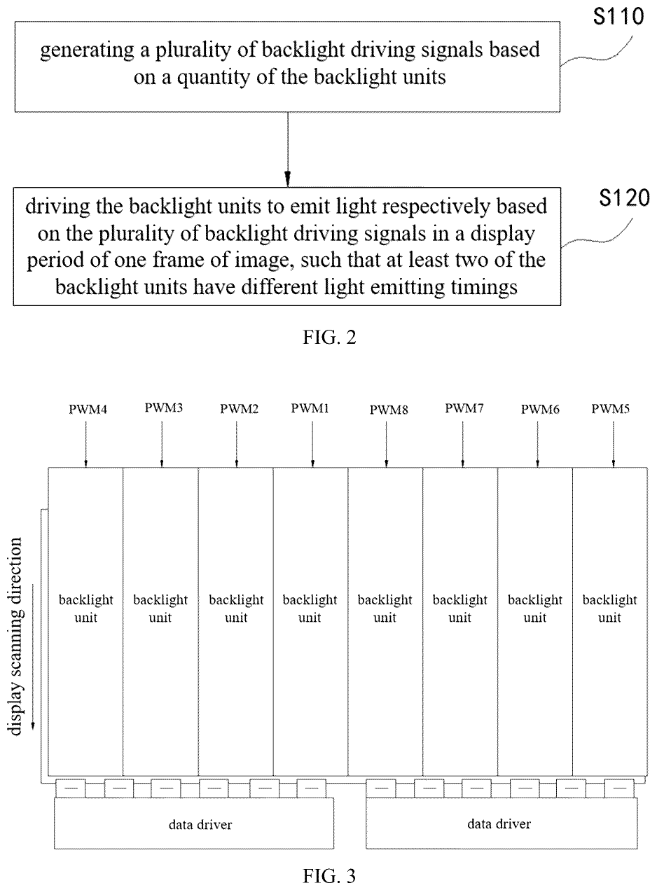

As shown in FIG. 2, in one embodiment, the present disclosure provides a method for controlling light emitting of a display screen. The display screen includes a plurality of backlight units arranged in sequence along a predetermined direction. The predetermined direction is perpendicular to the display scanning direction of the display screen. The method for controlling light emitting of the display screen includes operations S110 and S120, which are described in detail below.

Operation S110 may include generating a plurality of backlight driving signals based on a quantity of the backlight units. In some embodiments, each backlight driving signal is configured to control one backlight unit to emit light, and at least two of the backlight driving signals have different phases.

Referring to FIG. 3, by way of example and not as limitation, the quantity of backlight units may be eight. If the display scanning direction is the vertical direction, each backlight unit is arranged in sequence along the horizontal direction. The backlight driving signals may be pulse width modulation signals. The quantity of backlight driving signals is the same as the quantity of backlight units. The backlight driving signals include a first backlight driving signal PWM1, a second backlight driving signal PWM2, a third backlight driving signal PWM3, a fourth backlight driving signal PWM4, a fifth backlight driving signal PWM5, a sixth backlight driving signal PWM6, a seventh backlight driving signal PWM7 and an eighth backlight driving signal PWM8. The display screen further includes a data driver for outputting data signals to the pixel circuits, such that the pixel circuits can be charged based on the data signals to realize the display function.

Continuing to refer to FIG. 2, the sequence of the backlight driving signals for driving the backlight units can be set according to actual conditions. For example, the fourth backlight driving signal PWM4 is used to drive the first backlight unit, the third backlight driving signal PWM3 is used to drive the second backlight unit, the second backlight driving signal PWM2 is used to drive the third backlight unit, the first backlight driving signal PWM1 is used to drive the fourth backlight unit, the eighth backlight driving signal PWM8 is used to drive the fifth backlight unit, the seventh backlight driving signal PWM7 is used to drive the sixth backlight unit, the sixth backlight driving signal PWM6 is used to drive the seventh backlight unit, and the fifth backlight driving signal PWM5 is used to drive the eighth backlight unit. The specific setting can be determined according to actual needs, and this present disclosure does not impose any restriction in this regard.

Operation S120 may include driving the backlight units to emit light respectively based on the plurality of backlight driving signals in a display period of one frame of image, such that at least two of the backlight units have different light emitting timings.

By way of example and not as limitation, a backlight driving signal includes an active level state and an inactive level state, and the phase of the backlight driving signal is configured to represent the duration of the active level signal of the backlight driving signal. For example, in a scenario where the backlight unit is controlled to be turned on by a low level, the active level state of the backlight driving signal is a low level state, and the inactive level state of the backlight driving signal is a high level state. As such, for backlight driving signals with different phases, the time periods when they enter the active level state and the inactive level state are different, such that the backlight driving signals with different phases can result in different light emitting timings of the backlight units.

In the above implementation, a plurality of backlight driving signals with at least two different phases are generated based on the quantity of backlight units. Then, in the display period of one frame of image, the backlight units are driven to emit light based on the backlight driving signals, so that at least two of the backlight units have different light emitting timings in the display period of the one frame of image. Thus, during the charging process of pixel circuits in a same row, the pixel circuits in the same row can be charged both when the backlight units are on and when the backlight units are off. At this time, even if a bright strip is generated during the charging of the pixel circuits when the backlight units are on, the bright strip will not extend across the entire display screen. As such, the bright strips are relatively evenly distributed over the entire display screen visually, so that the waterfall pattern of the display screen can be reduced and the display effect can be improved without improving materials or manufacturing processes.

As an implementation of operation S110, operation S110 may include operations S111-S113, which are described in detail below.

Operation S111 may include obtaining a period interval amount based on a predetermined period of the backlight driving signals and the quantity of the backlight units.

By way of example and not as limitation, the predetermined period is less than or equal to the display period of one frame of image. For example, the display period of one frame of image may be several times or dozens of times the predetermined period. For example, when the refresh rate of the display screen is 60 Hz, the frequency of the backlight driving signals may be between 1.62 KHz and 1.86 KHz, the display period of one frame of image is 16.67 milliseconds, and the predetermined period of the backlight driving signals may be between 0.5 milliseconds and 1 millisecond.

By way of example and not as limitation, the predetermined period of the backlight driving signals is T, and T=0.8 milliseconds. The period interval amount is calculated based on the predetermined period T and the quantity N of backlight units (N=8). The predetermined period T can be evenly distributed to the backlight driving signals corresponding to the N backlight units, and the period interval amount can be expressed as (1/N)×T. When the predetermined period is 0.8 milliseconds and the quantity of backlight units is 8, the period interval amount is 0.1 milliseconds. The above-mentioned numerical values are merely for explaining the control logic and principle of the method for controlling light emitting provided by the present disclosure, and do not limit the actual application of the display screen. The actual parameter settings of the product can be determined according to actual conditions and requirements.

Operation S112 may include generating a phase offset amount for each of the backlight driving signals based on the period interval amount.

By way of example and not as limitation, a period offset amount can be generated for each backlight driving signal based on the period interval amount, and then the phase offset amount can be obtained for each backlight driving signal based on the period offset amount. The period offset amounts of the backlight driving signals range from zero period interval amounts to seven period interval amounts. Accordingly, the phase offset amounts of the plurality of backlight driving signals are 0, M, 2M, 3M, 4M, 5M, 6M and 7M, respectively, where M represents the period interval amount. As such, the phase offset amount of each backlight driving signal can be obtained, and the phase offset amount can control the temporal offset amount of the active level signal of the backlight driving signal.

Operation S113 may include generating a backlight driving signal corresponding to each backlight unit based on a predetermined duty cycle, the predetermined period and the phase offset amounts of the backlight driving signals.

By way of example and not as limitation, the predetermined duty cycle is the ratio of a duration of the active level of the backlight driving signal to the predetermined period. For example, if the duty cycle is 0.5, within one predetermined period T=0.8 milliseconds, the duration of the active level and the duration of the inactive level are both 0.4 milliseconds.

By way of example and not as limitation, the predetermined duty cycle is greater than or equal to 1/N. In some embodiments, N is the quantity of the backlight units. If the predetermined duty cycle is less than 1/N, and each adjacent backlight driving signal is shifted by one period interval amount in sequence, the sum of durations of the active levels will fail to cover the duration of the shifted period interval amount, which will lead to a timing when all backlight units are in the off state. However, by setting the predetermined duty cycle to be greater than or equal to 1/N, it is possible to ensure that at least one backlight unit is in the on state at all times, thereby providing the backlight source required for display.

As a possible implementation of operation S120, the plurality of backlight driving signals may be input to corresponding backlight units based on the phase offset amount of each backlight driving signal, such that at least two of the backlight units have different light emitting timings.

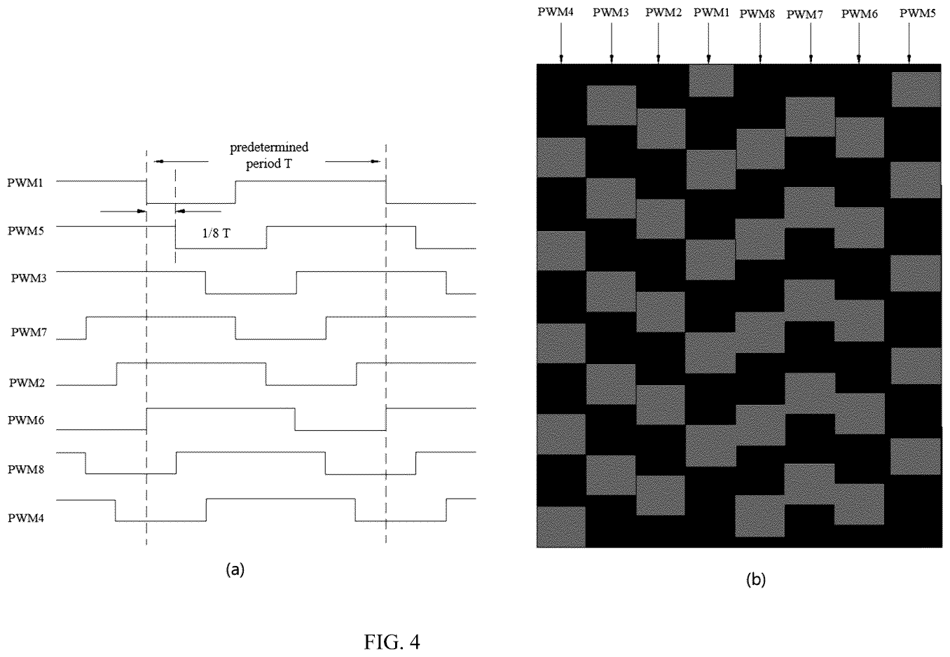

Referring to FIG. 4, in one embodiment, at least two backlight driving signals with a target phase difference may be input to corresponding target backlight units, respectively.

By way of example and not as limitation, the target phase difference refers to a difference between phase offset amounts being the period interval amount. With reference to illustration (a) in FIG. 4, there is a target phase difference between every two adjacent backlight driving signals. For example, there is a target phase difference between the first backlight driving signal PWM1 and the fifth backlight driving signal PWM5, between the fifth backlight driving signal PWM5 and the third backlight driving signal PWM3, and between the third backlight driving signal PWM3 and the seventh backlight driving signal PWM7, and so on so forth. When at least two backlight driving signals with a target phase difference control the corresponding two backlight units to be turned on respectively, the turn-on interval between the two backlight units is short. For instance, the turn-on interval is one period interval amount, and the duration of their simultaneous on-state is long.

In one embodiment, there is at least one other backlight unit between any two target backlight units, such that the light emitting timings of adjacent backlight units are separated by at least 2/N of the predetermined period. N is the quantity of the backlight units. Since at least two backlight driving signals with a target phase difference control the corresponding backlight units to be turned on with a short interval, the at least two backlight driving signals with a target phase difference are respectively input to the target backlight units that are separated by at least one other backlight unit. This ensures the target backlight units are two non-adjacent backlight units. As such, different backlight units with a short turn-on interval can be kept at a relatively large physical distance on the display screen, which makes it possible to disperse the generated bright strips to different positions on the display screen and thereby reduce the continuous area where the bright strips are formed.

With reference to FIG. 4, illustration (a) in FIG. 4 is a timing diagram of the backlight driving signals, and illustration (b) in FIG. 4 is a schematic diagram of the distribution of bright strips generated under the control of the backlight driving signals. By way of example and not as limitation, taking the period of the predetermined period depicted in illustration (a) in FIG. 4 as an example, the first backlight driving signal PWM1 first controls the fourth backlight unit to be turned on, and at the same time, the display screen starts to charge the pixel circuits in the first row. At this time, all backlight units except the fourth backlight unit are off, so a bright strip (shown by the gray rectangular grid in FIG. 4) is only formed at the fourth backlight unit. Then, the fifth backlight driving signal PWM5 controls the eighth backlight unit to be turned on. At this time, the fourth backlight unit and the eighth backlight unit are turned on at the same time. During this period, the pixel circuits are charged row by row with the fourth backlight unit and the eighth backlight unit turned on, so that bright strips are formed in the corresponding areas of the fourth backlight unit and the eighth backlight unit. Next, the third backlight driving signal PWM3 controls the second backlight unit to be turned on. At this time, the second backlight unit, the fourth backlight unit and the eighth backlight unit are turned on at the same time, and bright strips are formed in the corresponding areas of the second backlight unit, the fourth backlight unit and the eighth backlight unit. Then, the seventh backlight driving signal PWM7 controls the sixth backlight unit to be turned on. At this time, the first backlight driving signal PWM1 has entered the inactive level state, and the fourth backlight unit is turned off. Then, the second backlight unit, the sixth backlight unit and the eighth backlight unit are turned on at the same time, so that bright strips are formed in the corresponding areas of the second backlight unit, the sixth backlight unit and the eighth backlight unit. It can be known from the distribution of the areas where the bright strips appear as described above that each area where a bright strip appears is far apart on the display screen, with at least one backlight unit between them, so that the bright strips are dispersed on the entire display screen, and the waterfall pattern phenomenon can be reduced.

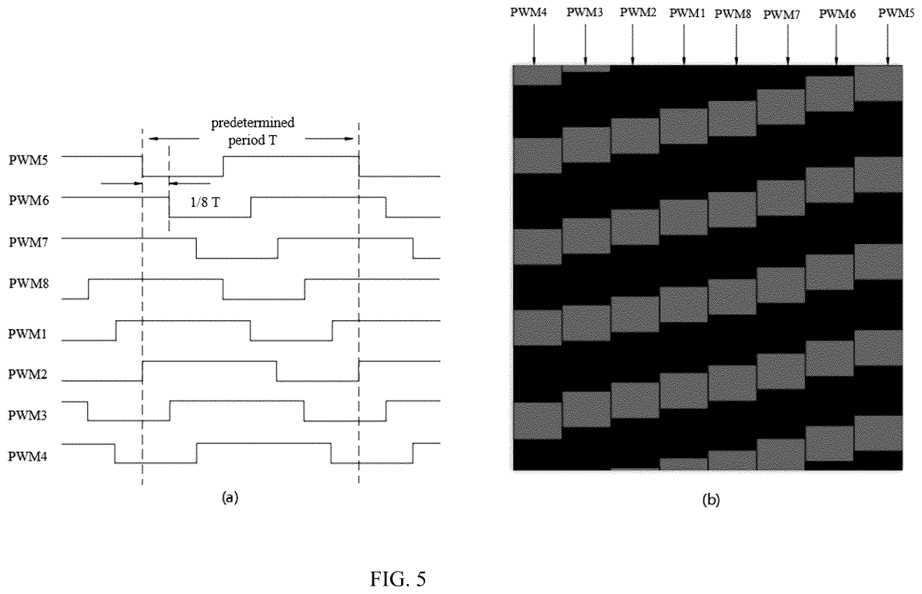

Referring to FIG. 5, in another embodiment, each of the backlight driving signals may be input to corresponding backlight unit in accordance with an arrangement order of the backlight units and based on an order of magnitudes of the phase offset amounts of the plurality of backlight driving signals, such that the light emitting timings of adjacent backlight units are sequentially separated by 1/N of the predetermined period. By way of example and not as limitation, taking the period of the predetermined period in illustration (a) in FIG. 5 as an example, based on the order of the magnitudes of the phase offset amounts, the phase offset amount of the fifth backlight driving signal PWM5 is 0, while the phase offset amounts of the sixth backlight driving signal PWM6, the seventh backlight driving signal PWM7, the eighth backlight driving signal PWM8, the first backlight driving signal PWM1, the second backlight driving signal PWM2, the third backlight driving signal PWM3 and the fourth backlight driving signal PWM4 increase in sequence. This ensures that the times when the sixth backlight driving signal PWM6, the seventh backlight driving signal PWM7, the eighth backlight driving signal PWM8, the first backlight driving signal PWM1, the second backlight driving signal PWM2, the third backlight driving signal PWM3 and the fourth backlight driving signal PWM4 enter the active level are sequentially increased by one period interval amount compared with the time when the fifth backlight driving signal PWM5 enters the active level.

With reference to FIG. 5, illustration (a) in FIG. 5 is a timing diagram of the backlight driving signals, and illustration (b) in FIG. 5 is a schematic diagram of the distribution of bright strips generated under the control of the backlight driving signals. The fifth backlight driving signal PWM5 first controls the eighth backlight unit to be turned on, and at the same time, the display screen starts to charge the pixel circuits in the first row. At this time, all backlight units except the eighth backlight unit are off, so a bright strip is only formed at the eighth backlight unit. Then, the sixth backlight driving signal PWM6 controls the seventh backlight unit to be turned on. At this time, the seventh backlight unit and the eighth backlight unit are turned on at the same time. During this period, the pixel circuits are charged row by row with the seventh backlight unit and the eighth backlight unit turned on, so that bright strips are formed in the corresponding areas of the seventh backlight unit and the eighth backlight unit. Next, the seventh backlight driving signal PWM7 controls the sixth backlight unit to be turned on. At this time, the sixth backlight unit, the seventh backlight unit and the eighth backlight unit are turned on at the same time, and bright strips are formed in the corresponding areas of the sixth backlight unit, the seventh backlight unit and the eighth backlight unit. Then, the eighth backlight driving signal PWM8 controls the fifth backlight unit to be turned on. At this time, the fifth backlight driving signal PWM5 has entered the inactive level state, and the eighth backlight unit is turned off. Then, the fifth backlight unit, the sixth backlight unit and the seventh backlight unit are turned on at the same time, so that bright strips are formed in the corresponding areas of the fifth backlight unit, the sixth backlight unit and the seventh backlight unit. As such, through the sequential turning on and off of the plurality of backlight units, the bright strips appear and disappear sequentially at the corresponding positions of the display screen. This also enables the dispersion of the bright strips, so as to reduce the waterfall pattern phenomenon.

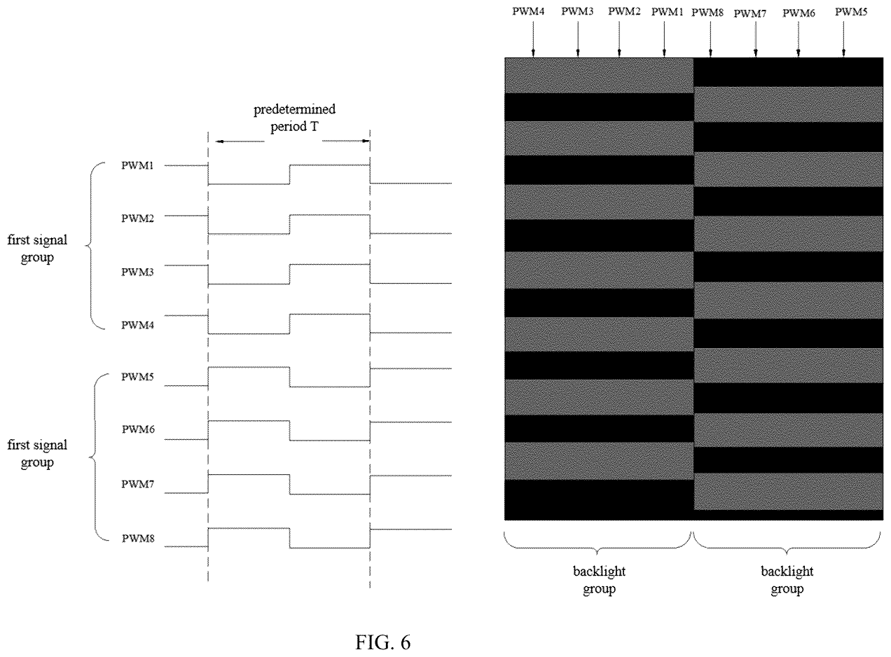

Referring to FIG. 6, as another possible implementation of operation S120, the backlight units are divided into a plurality of backlight groups, the backlight driving signals include a plurality of first signal groups, phases of each of the backlight driving signals in a same first signal group are equal, and phases of the backlight driving signals in different first signal groups are different. In operation S120, the plurality of first signal groups may be input to respective backlight groups, such that the backlight units in a same backlight group have a same light emitting timing and the backlight units in different backlight groups have different light emitting timings.

By way of example and not as limitation, the backlight units are divided into a plurality of backlight groups, and the number of backlight groups may be two or more. The first signal groups ensure that the backlight units in the same backlight group have the same light-emitting timing, while the backlight units in different backlight groups have different light-emitting timings. As such, when the pixel circuits are being charged, bright strips are only generated at the corresponding positions of the backlight groups in the on state. These bright strips will not extend across an entire row of pixel circuits, which can also reduce the waterfall pattern phenomenon to a certain extent.

With reference to FIG. 6, illustration (a) in FIG. 6 is a timing diagram of the backlight driving signals, and illustration (b) in FIG. 6 is a schematic diagram of the distribution of bright strips generated under the control of the backlight driving signals. In illustration (a) of FIG. 6, the first backlight driving signal PWM1, the second backlight driving signal PWM2, the third backlight driving signal PWM3 and the fourth backlight driving signal PWM4 are at the active level in the first half of the predetermined period to control the backlight units in the first backlight group to be turned on. At this time, the backlight units in the second backlight group are off. As the pixel circuits are charged row by row, bright strips are generated at the corresponding positions of the first backlight group, while no bright strips are generated at the corresponding positions of the second backlight group. The fifth backlight driving signal PWM5, the sixth backlight driving signal PWM6, the seventh backlight driving signal PWM7 and the eighth backlight driving signal PWM8 are at the active level in the second half of the predetermined period to control the backlight units in the second backlight group to be turned on. At this time, the backlight units in the first backlight group are off, so that bright strips are generated at the corresponding positions of the second backlight group, while no bright strips are generated at the corresponding positions of the first backlight group. As such, in each row of the display screen, bright strips are generated at the corresponding positions of at most one backlight group in the same time period, and the bright strips will not extend across the entire display screen, so the waterfall pattern phenomenon can also be reduced.

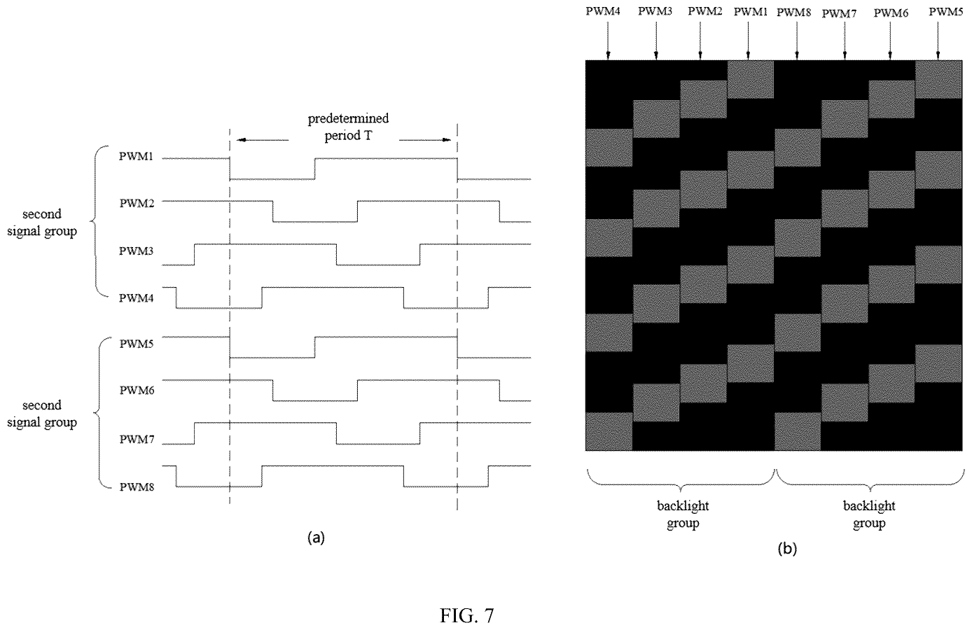

Referring to FIG. 7, as yet another possible implementation of operation S120, the backlight units are divided into a plurality of backlight groups, the backlight driving signals include a plurality of second signal groups, and phases of the backlight driving signals in a same second signal group are different. As such, in operation S120, the plurality of second signal groups may be input to respective backlight groups, such that the backlight units in a same backlight group have different light emitting timings, and each backlight unit in each backlight group has a same light emitting timing as one of the backlight units in another backlight groups.

By way of example and not as limitation, the backlight units are divided into a plurality of backlight groups. The second signal group ensures that the backlight units within the same backlight group have different light-emitting timings, while each backlight unit in a backlight group shares the same light-emitting timing with one backlight unit from another backlight group. As such, when the pixel circuits are being charged, backlight units that are physically close to each other on the display screen will not be turned on simultaneously, thus preventing the formation of large-area bright bands. In contrast, backlight units from different backlight groups are physically far apart on the display screen. When turned on simultaneously, the bright bands these backlight units generate will be dispersed, which helps reduce the waterfall pattern phenomenon.

With reference to FIG. 7, illustration (a) in FIG. 7 is a timing diagram of the backlight driving signals, and illustration (b) in FIG. 7 is a schematic diagram of the distribution of bright strips generated under the control of the backlight driving signals. By way of example and not as limitation, the timings when the first backlight driving signal PWM1, the second backlight driving signal PWM2, the third backlight driving signal PWM3 and the fourth backlight driving signal PWM4 enter the active level may increase by one period offset amount in sequence. Similarly, the timings when the fifth backlight driving signal PWM5, the sixth backlight driving signal PWM6, the seventh backlight driving signal PWM7 and the eighth backlight driving signal PWM8 enter the active level may increase by one period offset amount in sequence. In addition, the first backlight driving signal PWM1 is the same as the fifth backlight driving signal PWM5, the second backlight driving signal PWM2 is the same as the sixth backlight driving signal PWM6, and so on so forth.

Specifically, the fourth backlight unit and the eighth backlight unit are controlled to be turned on at the same time by the first backlight driving signal PWM1 and the fifth backlight driving signal PWM5. As the pixel circuits are charged, bright strips are generated at the corresponding positions of the fourth backlight unit and the eighth backlight unit. Then, the third backlight unit and the seventh backlight unit are controlled to be turned on at the same time by the second backlight driving signal PWM2 and the sixth backlight driving signal PWM6. As the pixel circuits are charged, bright strips are generated at the corresponding positions of the third backlight unit and the seventh backlight unit, and so on so forth. In this way, since the backlight units turned on each time are distributed in different backlight groups and are far apart in physical distance on the display screen, the generated bright strips will be dispersed. In the same backlight group, although the physical distance on the display screen is close, the backlight units are turned on at different timings, so that no bright strips are generated simultaneously in the area corresponding to the same backlight group. As such, the waterfall pattern phenomenon can be effectively reduced.

In one embodiment, the present disclosure provides a display screen, including a light emitting control unit and a plurality of backlight units.

In some embodiments, the plurality of backlight units are arranged in sequence along a predetermined direction, and the predetermined direction is perpendicular to a display scanning direction of the display screen. The light emitting control unit is connected to the backlight units and configured to generate a plurality of backlight driving signals based on a quantity of the backlight units, where each backlight driving signal is configured to control one of the backlight units to emit light, and at least two of the backlight driving signals have different phases; and drive the backlight units to emit light respectively based on the plurality of backlight driving signals in a display period of one frame of image, such that at least two of the backlight units have different light emitting timings.

In the above embodiments, the description of each embodiment has its own focus. For the part that is not described in detail in an embodiment, reference may be made to the relevant descriptions of other embodiments.

The above are only preferred embodiments of the present disclosure and are not intended to limit the present disclosure in any form. However, any modification, equivalent change and modification made to the above embodiments according to the technical essence of the present disclosure without departing from the content of the technical solution of the present disclosure still fall within the scope of the technical solution of the present disclosure.

What is claimed is:

1. A method for controlling light emitting of a display screen, wherein the display screen comprises a plurality of backlight units arranged in sequence along a predetermined direction, the predetermined direction is perpendicular to a display scanning direction of the display screen, the method comprising:
generating a plurality of backlight driving signals based on a quantity of the backlight units, wherein each backlight driving signal is configured to control one of the backlight units to emit light, and at least two of the backlight driving signals have different phases;
driving the backlight units to emit light respectively based on the plurality of backlight driving signals in a display period of one frame of image, such that at least two of the backlight units have different light emitting timings.

2. The method for controlling light emitting of a display screen of claim 1, wherein the generating of the plurality of backlight driving signals based on the quantity of the backlight units comprises:
obtaining a period interval amount based on a predetermined period of the backlight driving signals and the quantity of the backlight units;
generating a phase offset amount for each of the backlight driving signals based on the period interval amount;
generating a backlight driving signal corresponding to each backlight unit based on a predetermined duty cycle, the predetermined period and the phase offset amounts of the backlight driving signals.

3. The method for controlling light emitting of a display screen of claim 2, wherein the period interval amount is calculated as (1/N)×T, where N represents the quantity of the backlight units and T represents the predetermined period.

4. The method for controlling light emitting of a display screen of claim 2, wherein the predetermined period is less than or equal to the display period of the one frame of image.

5. The method for controlling light emitting of a display screen of claim 2, wherein the predetermined duty cycle is greater than or equal to 1/N, wherein N is the quantity of the backlight units.

6. The method for controlling light emitting of a display screen of claim 2, wherein the driving of the backlight units to emit light respectively based on the plurality of backlight driving signals such that at least two of the backlight units have different light emitting timings comprises:
inputting the plurality of backlight driving signals to corresponding backlight units based on the phase offset amount of each backlight driving signal, such that at least two of the backlight units have different light emitting timings.

7. The method for controlling light emitting of a display screen of claim 6, wherein the inputting of the plurality of backlight driving signals to the corresponding backlight units based on the phase offset amount of each backlight driving signal comprises:
inputting at least two backlight driving signals with a target phase difference to corresponding target backlight units, respectively, wherein there is at least one other backlight unit between any two target backlight units, such that the light emitting timings of adjacent backlight units are separated by at least 2/N of the predetermined period,
wherein N is the quantity of the backlight units, and the target phase difference refers to a difference between phase offset amounts being the period interval amount.

8. The method for controlling light emitting of a display screen of claim 6, wherein the inputting of the plurality of backlight driving signals to the corresponding backlight units based on the phase offset amount of each backlight driving signal such that at least two of the backlight units have different light emitting timings comprises:
inputting each of the backlight driving signals to corresponding backlight unit in accordance with an arrangement order of the backlight units and based on an order of magnitudes of the phase offset amounts of the plurality of backlight driving signals, such that the light emitting timings of adjacent backlight units are sequentially separated by 1/N of the predetermined period,
wherein N is the quantity of the backlight units.

9. The method for controlling light emitting of a display screen of claim 1, wherein the backlight units are divided into a plurality of backlight groups; the backlight driving signals comprise a plurality of first signal groups, phases of each of the backlight driving signals in a same first signal group are equal, and phases of the backlight driving signals in different first signal groups are different;
the driving of the backlight units to emit light respectively based on the plurality of backlight driving signals such that at least two of the backlight units have different light emitting timings comprises:
inputting the plurality of first signal groups to respective backlight groups, such that the backlight units in a same backlight group have a same light emitting timing and the backlight units in different backlight groups have different light emitting timings.

10. The method for controlling light emitting of a display screen of claim 1, wherein the backlight units are divided into a plurality of backlight groups; the backlight driving signals comprise a plurality of second signal groups, and phases of the backlight driving signals in a same second signal group are different;
the driving of the backlight units to emit light respectively based on the plurality of backlight driving signals such that at least two of the backlight units have different light emitting timings comprises:
inputting the plurality of second signal groups to respective backlight groups, such that the backlight units in a same backlight group have different light emitting timings, and each backlight unit in each backlight group has a same light emitting timing as one of the backlight units in another backlight group.

11. A display screen, comprising:
a plurality of backlight units, arranged in sequence along a predetermined direction, wherein the predetermined direction is perpendicular to a display scanning direction of the display screen;
a light emitting control unit, connected to the backlight units and configured to perform the following operations:
generating a plurality of backlight driving signals based on a quantity of the backlight units, wherein each backlight driving signal is configured to control one of the backlight units to emit light, and at least two of the backlight driving signals have different phases;
driving the backlight units to emit light respectively based on the plurality of backlight driving signals in a display period of one frame of image, such that at least two of the backlight units have different light emitting timings.

12. The display screen of claim 11, wherein the light emitting control unit is configured to generate the plurality of backlight driving signals based on the quantity of the backlight units by:
obtaining a period interval amount based on a predetermined period of the backlight driving signals and the quantity of the backlight units;
generating a phase offset amount for each of the backlight driving signals based on the period interval amount;
generating a backlight driving signal corresponding to each backlight unit based on a predetermined duty cycle, the predetermined period and the phase offset amounts of the backlight driving signals.

13. The display screen of claim 12, wherein the light emitting control unit is configured to calculate the period interval amount as (1/N)×T, where N represents the quantity of the backlight units and T represents the predetermined period.

14. The display screen of claim 12, wherein the predetermined period is less than or equal to the display period of the one frame of image.

15. The display screen of claim 12, wherein the predetermined duty cycle is greater than or equal to 1/N, wherein N is the quantity of the backlight units.

16. The display screen of claim 12, wherein the light emitting control unit is configured to drive the backlight units to emit light respectively based on the plurality of backlight driving signals such that at least two of the backlight units have different light emitting timings by:
inputting the plurality of backlight driving signals to corresponding backlight units based on the phase offset amount of each backlight driving signal, such that at least two of the backlight units have different light emitting timings.

17. The display screen of claim 16, wherein the light emitting control unit is configured to input the plurality of backlight driving signals to the corresponding backlight units based on the phase offset amount of each backlight driving signal by:
inputting at least two backlight driving signals with a target phase difference to corresponding target backlight units, respectively, wherein there is at least one other backlight unit between any two target backlight units, such that the light emitting timings of adjacent backlight units are separated by at least 2/N of the predetermined period,
wherein N is the quantity of the backlight units, and the target phase difference refers to a difference between phase offset amounts being the period interval amount.

18. The display screen of claim 16, wherein the light emitting control unit is configured to input the plurality of backlight driving signals to the corresponding backlight units based on the phase offset amount of each backlight driving signal such that at least two of the backlight units have different light emitting timings by:
inputting each of the backlight driving signals to corresponding backlight unit in accordance with an arrangement order of the backlight units and based on an order of magnitudes of the phase offset amounts of the plurality of backlight driving signals, such that the light emitting timings of adjacent backlight units are sequentially separated by 1/N of the predetermined period,
wherein N is the quantity of the backlight units.

19. The display screen of claim 11, wherein the backlight units are divided into a plurality of backlight groups; the backlight driving signals comprise a plurality of first signal groups, phases of each of the backlight driving signals in a same first signal group are equal, and phases of the backlight driving signals in different first signal groups are different;
the light emitting control unit is configured to drive the backlight units to emit light respectively based on the plurality of backlight driving signals such that at least two of the backlight units have different light emitting timings by:
inputting the plurality of first signal groups to respective backlight groups, such that the backlight units in a same backlight group have a same light emitting timing and the backlight units in different backlight groups have different light emitting timings.

20. The display screen of claim 11, wherein the backlight units are divided into a plurality of backlight groups; the backlight driving signals comprise a plurality of second signal groups, and phases of the backlight driving signals in a same second signal group are different;
the light emitting control unit is configured to drive the backlight units to emit light respectively based on the plurality of backlight driving signals such that at least two of the backlight units have different light emitting timings by:
inputting the plurality of second signal groups to respective backlight groups, such that the backlight units in a same backlight group have different light emitting timings, and each backlight unit in each backlight group has a same light emitting timing as one of the backlight units in another backlight group.
